(19) United States
(12) Patent Application Publication
(10) Pub. No.: US 2005/0204620 A1
(43) Pub. Date: Sep. 22, 2005

(54) Hydroponic plant growth system and method

(76) Inventors: Walter E. Butterfield, McKinleyville, CA (US); William Charles Baker, McKinleyville, CA (US)

Correspondence Address: LAW OFFICE OF MICHAEL P. EDDY, 12526 HIGH BLUFF DRIVE, STE. 300, SAN DIEGO, CA, 92130, US

(21) Appl. No.: 10/806,764

(22) Filed: Mar. 22, 2004

(51) Int. Cl. A01G 31/00

(52) U.S. Cl. 47/62 E

(57) ABSTRACT

One embodiment of the present invention includes a plant growth system consisting of a vertically positioned source of light, a reservoir, a pump, a volume of liquid based nutrient composition, a plurality of independent growing chambers arranged in a planar array around said one or more sources of light, each of said growing chambers comprising a container portion with a base and sides, an inflow/outflow gate accommodated in the base of said container portion, an height adjustable overflow gate accommodated within said container portion, and drainage plumbing connecting said container portion with said reservoir, and wherein each of said growing chambers accommodates one or more plant holding containers, wherein when said pump is activated, said pump transports said nutrient composition from the reservoir through the inflow/outflow gate into said growing chambers, and wherein when one of said growing chambers becomes flooded to the level of said overflow gate, said overflowing nutrient composition is returned to said reservoir via said drainage plumbing, and wherein when said pump is deactivated, said nutrient composition remaining in each growing chamber returns to the reservoir via the inflow/outflow gate.

### CROSS-REFERENCES TO OTHER RELATED PATENT APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The present invention relates generally to the field of plant growing systems and methods, and more specifically plant growth systems using hydroponics. Hydroponic growth methods typically grow plants in water with special chemicals or nutrients added, and this method is typically used in growing outside the earth and without soil. Hydroponic methods use a variety of ways to provide water, nutrients and oxygen to the plants. In a simple method, passive hydroponics, a plant is planted in a container (pot or bag) of growing medium, and the container stands in a tray of nutrient solution. The simple system is maintained by topping off the level of the nutrient solution and occasionally replacing the nutrient solution.

Some other common methods are the “flood/drain” method and the “flow” method. In the flow method, also known as drip feeding, a pump is used to deliver a continuous trickle of liquid nutrient through a cultivation area where plant seeds or young plants are accommodated. In typical “flood/drain” methods, a large open tray sits above a reservoir of nutrient solution. The tray can be filled with a growing medium, for example clay granules. Plant seeds or young plants, typically accommodated in slotted pots or slotted bags, are placed in the tray. A pump fills the upper tray with nutrient via the inflow/outflow valve until the tray fills and the nutrient drains back down into the reservoir via the overflow valve. This action allows the medium to be regularly flushed with nutrient and air. The pump is typically controlled by a timer which is programmed to repeat this cycle at regular intervals. Once the pump is shut off, the nutrient remaining in the tray drains back out the inflow/outflow valve into the reservoir.

Most hydroponic techniques, dispensing with the use of soil, use relatively inert materials as a physical support for the plant roots. Other techniques dispense altogether with any growing medium, delivering nutrient solution directly to the roots, by a variety of methods. Generally, a liquid nutrient composition is circulated through a cultivation portion where the plant seeds or young plants are anchored and grown. Water and nutrients are delivered to the roots via capillary action, as the medium generally has large air spaces, allowing ample oxygen and nutrients to reach the roots of the young plants and seeds. A variety of materials can be used for the medium: vermiculite, perlite, clay granules, hydrostone, rockwool, gravel, coir fibre, and cocoa bean shells.

### BRIEF SUMMARY OF THE INVENTION

The present invention combines the very common “flood/drain,” also known as the “ebb and flow” method found in traditional flat rectangular hydroponic trays with one or more vertically positioned light sources. One embodiment of the present invention includes a plant growth system consisting of a vertically positioned source of light, a reservoir, a pump, a volume of liquid based nutrient composition, a plurality of independent growing chambers arranged in a planar array around said one or more sources of light, each of said growing chambers comprising a container portion with a base and sides, an inflow/outflow gate accommodated in the base of said container portion, an height adjustable overflow gate accommodated within said container portion, and drainage plumbing connecting said container portion with said reservoir, and wherein each of said growing chambers accommodates one or more plant holding containers, wherein when said pump is activated, said pump transports said nutrient composition from the reservoir through the inflow/outflow gate into said growing chambers, and wherein when one of said growing chambers becomes flooded to the level of said overflow gate, said overflowing nutrient composition is returned to said reservoir via said drainage plumbing, and wherein when said pump is deactivated, said nutrient composition remaining in each growing chamber returns to the reservoir via the inflow/outflow gate.

Another embodiment of the present invention includes a plurality of vertically positioned sources of light.

Another embodiment of the present invention is comprised primarily of a polyethylene material.

Another embodiment of the present invention has a plurality of inflow/outflow gates instead of a single inflow/outflow gate.

Another embodiment of the present invention has a plurality of overflow gates instead of a single overflow gate.

Another embodiment of the present invention includes a timer to activate and deactivate the pump.

Another embodiment of the present invention is a plant growth method comprising the steps of: activating a pump wherein said pump transports said nutrient composition from the reservoir through the inflow/outflow gate into said growing chambers; and wherein when one of said growing chambers becomes flooded to the level of said overflow gate, said overflowing nutrient composition is returned to said reservoir via said drainage plumbing; and deactivating said pump wherein said nutrient composition that is remaining in each growing chamber returns to the reservoir via the inflow/outflow gate using an using an apparatus comprised of a vertically positioned source of light, the reservoir, the pump, the volume of liquid based nutrient composition, a plurality of stacked independent growing chambers arranged in a planar array around said one or more sources of light, each of said growing chambers comprising a container portion with a base and sides, an inflow/outflow gate accommodated in the base of said container portion, an height adjustable overflow gate accommodated within said container portion; and drainage plumbing connecting said container portion with said reservoir wherein each of said growing chambers accommodates one or more plant holding containers.

Having thus described embodiments of the present invention, it is the principal object of the present invention to provide an improved hydroponic growing chamber.

### BRIEF DESCRIPTION OF THE SEVERAL VIEWS OF THE DRAWINGS

The above and other objects, advantages and features of the present invention will be more readily apparent from the following description, when read in conjunction with the accompanying drawings wherein:

FIG. 1 is a perspective view of an embodiment of the present invention;

FIG. 2 is breakaway partial side view of the growing chamber of an embodiment of the present invention;

FIG. 3 is an end cut away view of a growing chamber of an embodiment of the present invention;

FIG. 4 is a side cut away view of a growing chamber of an embodiment of the present invention;

FIG. 5 is a partial perspective view of a growing chamber of an embodiment of the present invention;

FIG. 6 is a partial perspective view of a growing chamber of an embodiment of the present invention;

FIG. 7 is a partial perspective view of a growing chamber of an embodiment of the present invention;

FIG. 8 is a partial perspective view of a growing chamber of an embodiment of the present invention;

FIG. 9 is a top perspective view of a growing chamber of an embodiment of the present invention;

FIG. 10 is a top perspective view of a growing chamber of an embodiment of the present invention;

### DETAILED DESCRIPTION OF THE INVENTION

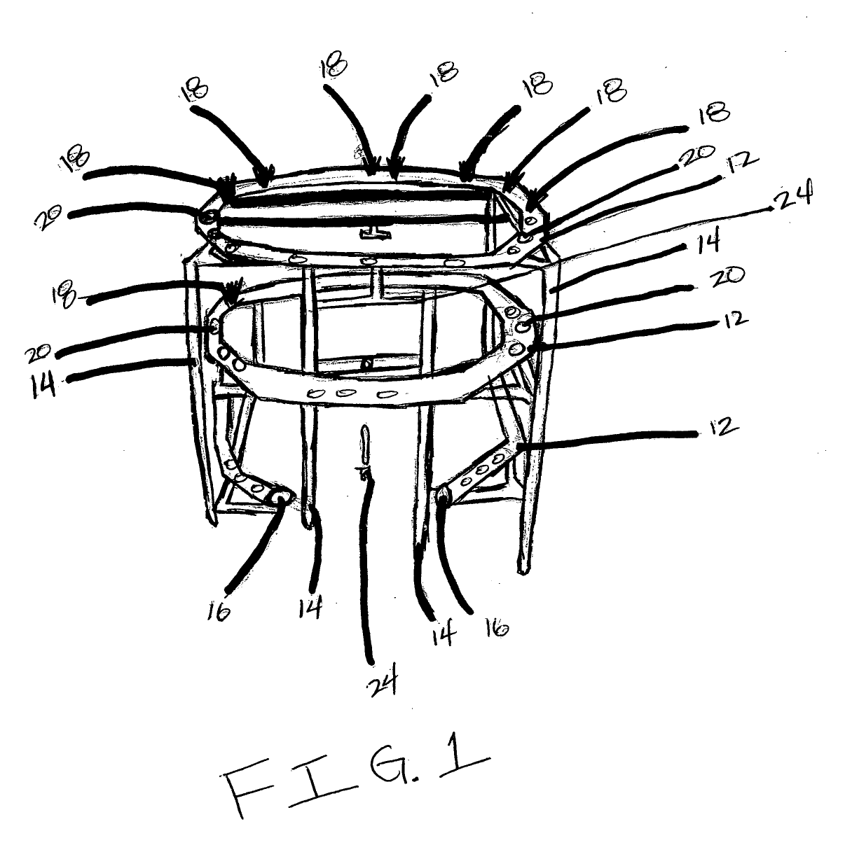

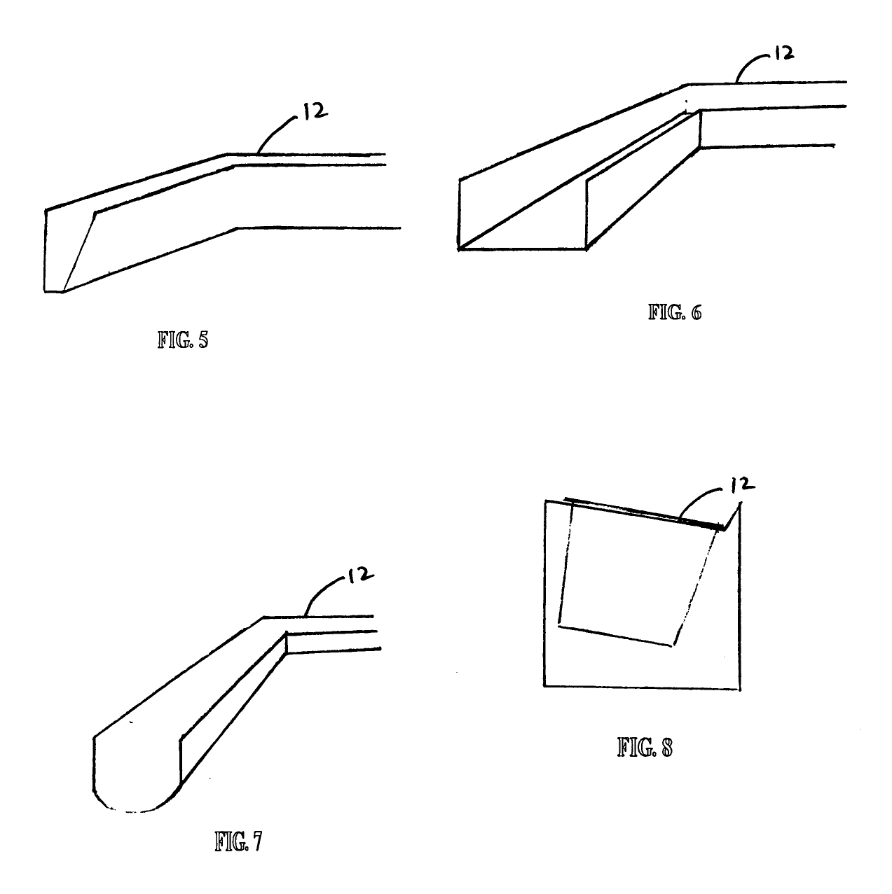

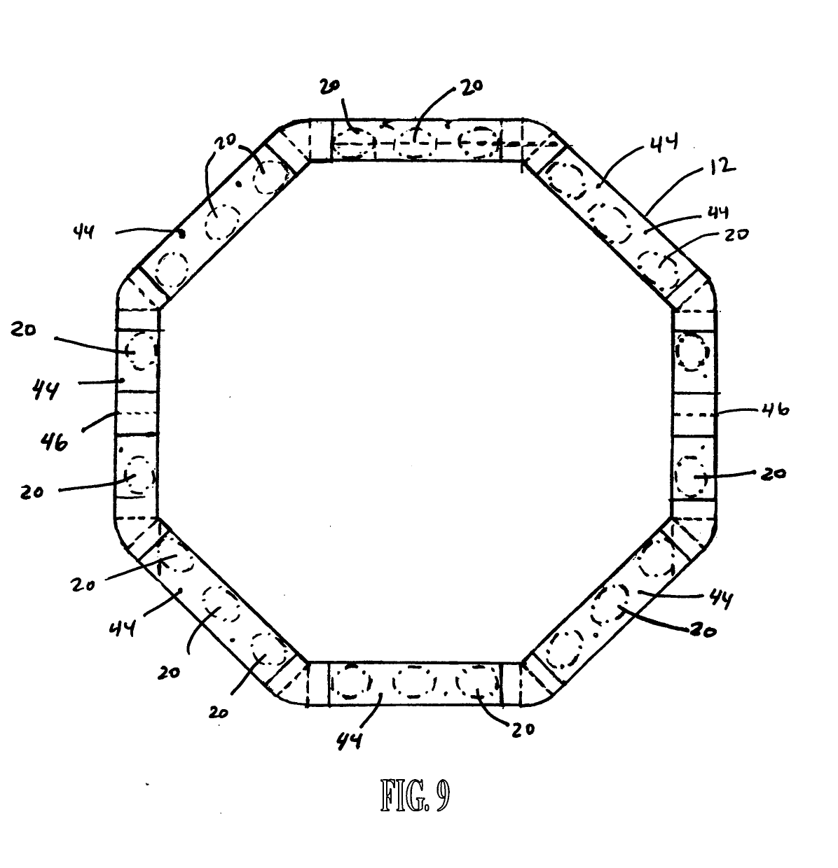

Turning now descriptively to the drawings, in which similar reference characters denote similar elements throughout several views, FIGS. 1 through 13 illustrate an embodiment of the hydroponic growing system designated generally by the numeral 10. In this system 10, a liquid nutrient composition is circulated through a cultivation portion consisting of a plurality of growing chambers 12. Growing chambers 12 can be formed in the shape of a tray, a tube, or a circular shaped container, or any suitable form for accommodating plant pots or bags.

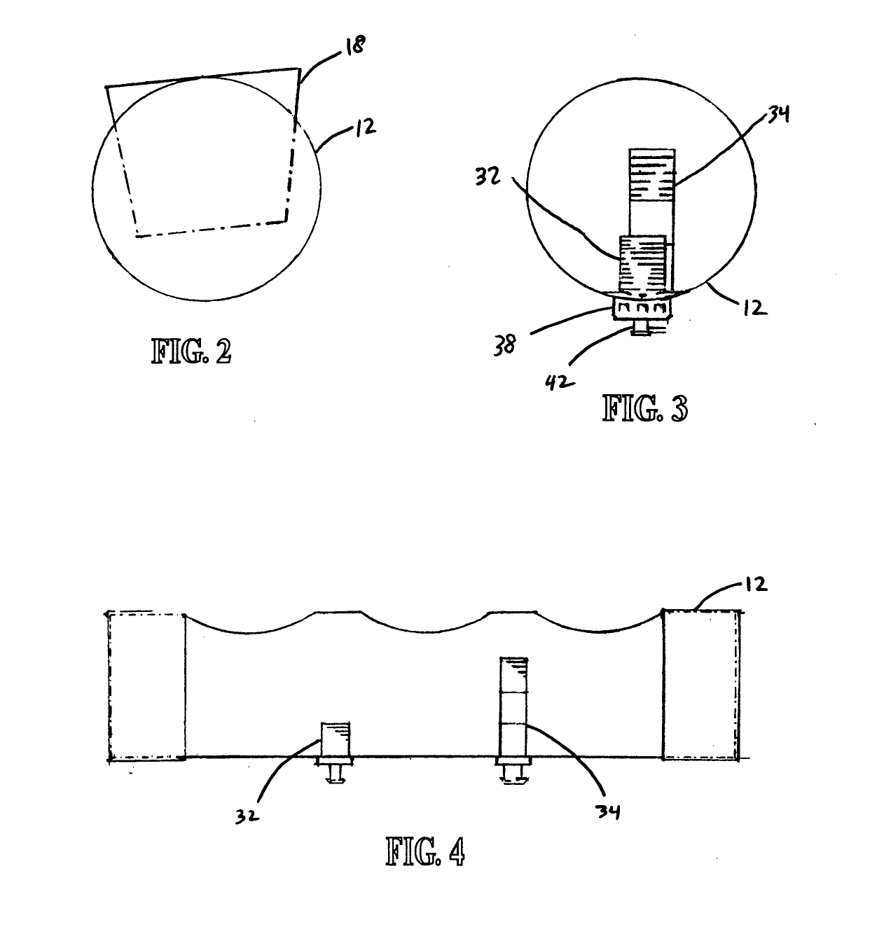

FIG. 1. illustrates an embodiment of system 10 which is made up of three independently plumbed growing chambers 12 set upon a support structure 14. The two uppermost growing chambers 12 are in the form of an eight sided octagon. The lowermost positioned growing chamber 12 shown is made up of seven sides and includes two polyethylene end caps 16 so that said lowermost chamber 12 is sealed on both ends. Plant pots 18 (shown containing young plants) are positioned to seat individually into openings 20. Each Pot 18 has a diameter of 5″ at its top end and each is tapered so that the pot 18 can be slide and fit securely into opening 20. Each growing chamber 12 has a plurality of openings 20 in the tops of the chambers 12 in order to accommodate various sized plant pots 18 or plant holding bags. FIG. 2 illustrates a side breakaway view of a plant pot 18 as it is seated into a section of growing chamber 12.

Growing chambers 12 can also accommodate one or more sizes of plant pots 18, bags, or the like. Commonly used sizes of plant pots 18 are diameter sizes of 5″, 4″ and 3.″ The plant pots 18 or bags have openings or slots to allow the nutrient liquid to flow through the pots or bags to the roots or seeds. The scope of the invention is not limited to plant pots or bags, as the present invention can easily be modified to hold any other object wherein the plant seeds or young plants are anchored.

Growing chambers 12 are individually stacked or set upon support structure 14, which is also constructed of a plastic piping. Growing chambers 20 can also be supported by other means such as with horizontal shelf supports, support wires or similar support means. The support structure 14 is at a level pitch and is positioned above reservoir tank 22 (not shown.) More than one reservoir tank 22 can also be used instead of a single reservoir tank 22.

A commercially available vertical hung light fixture 24 is placed on the ground or hung from the ceiling and anchored at the floor. Fixture 24 provides the source of light needed to plant growth. Fixture 24 can also be used with no anchoring, and fixture 24 can further be made up of several individual sources of light.

Each growing chamber 12, both with and without end caps 16, is comprised of a pipe or a tray style container with at least a base with two sides and each growing chamber 12 includes an inlet/outlet gate 32 located at the base of growing chamber 12, an overflow gate 34, and drain plumbing 36, and each growing chamber 12 is primarily made up of piping, plastic fittings and molded plastic pieces. FIG. 3 illustrates a view from an open end of an embodiment of a growing chamber 12 with an inlet/outlet gate 32 and an overflow gate 34 using compression fittings 38 and connected to drain plumbing 36 via hose 42 which has a barbed connection to secure the hose in place. The diameter of the inlet/outlet gate 32 as well as the overflow gate 34 is ¾″ and the diameter of hose 42 is ⅜″. FIG. 4. illustrates a side view of an embodiment of a growing chamber 12 with examples of an inlet/outlet gate 32 positioned near the base of chamber 12 and an adjustable overflow gate 34 which is positioned near the top of chamber 12. The overflow gate 34 is adjustable by the user to various height levels.

The growing chambers 12 can be constructed of a plastic polymer such as PVC, plastic pieces or any like material. FIGS. 5 through 8 illustrate various embodiments of the base and two sides in the growing chamber 12. These illustrations do not show inlet/outlet gate 32, overflow gate 34 or drain plumbing 36.

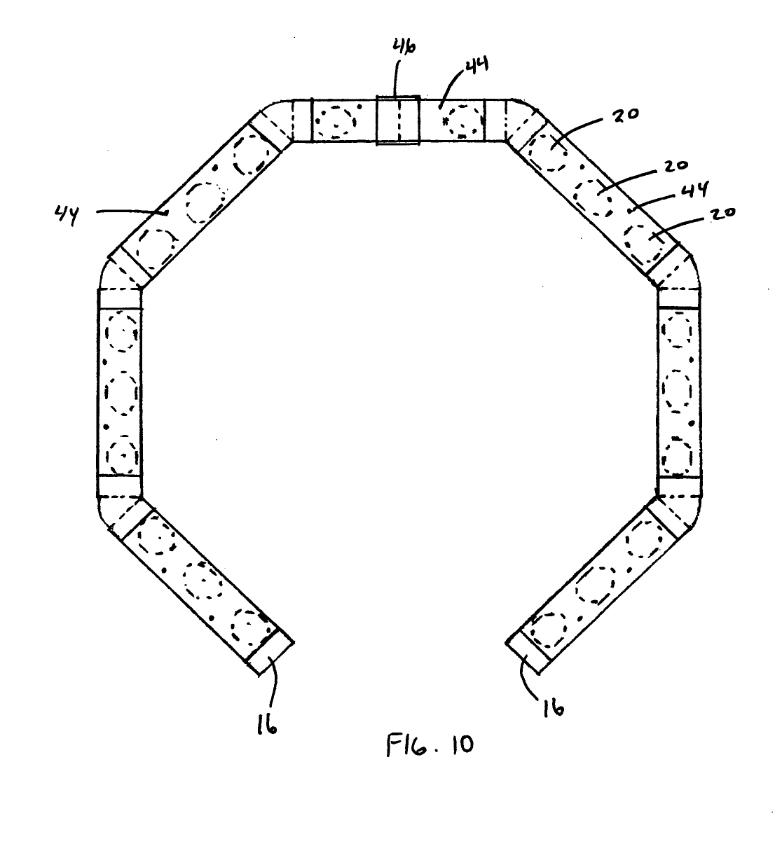

Illustrated in FIG. 9 is a top view of the upper two growing chambers 12 of the three growing chambers 12 shown in system 10. Each has eight sides which are approximately 25″ in length and which are connected by 45 degree elbow joints. Each of these growing chambers 12 also has a plurality of ½″ vent holes 44. Some sections are joined by a 6″ length plastic coupler 46. The diameter (from the exterior walls of each side) of the growing chamber 12 as illustrated in FIG. 9 is 72″ and the diameter of the interior open space is 66″. Illustrated in FIG. 10 is a top view of the lower most growing chamber 12 of the three growing chambers 12 shown in system 10. This growing chamber 12 has seven sides and two end caps 16 placed on each end to seal the lowest positioned growing chamber 12.

Using the “flood/drain” method, in contrast to the “flow” method wherein nutrient solution is provided to the plants in a flow that moves from top to bottom, the plants and plant seeds in the growing chambers 12 of the present invention are flooded from the bottom portion at the base of each growing chamber 12 until growing chambers 12 fill to the level of the overflow gate 34. As previously mentioned, the overflow gate 34 level is adjustable by manually raising or lowering the height of the overflow gate 34. In other embodiments, this height can be remotely controlled. When the volume of liquid nutrient composition reaches the level of overflow gate 34, the nutrient runs into overflow gate 34 and is returned to reservoir 22 via hose 42 and drain plumbing 36.

Generally, when pump 48 (no shown) is activated by the user, liquid nutrient composition is pumped from reservoir 22 into the base of growing chamber 12 via inlet/outlet gate 32 until the level of liquid nutrient composition in growing chamber 12 fills to the level of the adjustable overflow gate 34. Once the liquid nutrient reaches the level of the opening in overflow gate 34, the liquid nutrient is returned to reservoir 22 via hose 42 and drain plumbing 36. When pump 48 is deactivated by the user, the volume of liquid nutrient composition remaining in growing chamber 12 drains back down into reservoir 22 via inlet/outlet gate 32. Pump 48 can be any commercially available pump suitable for pumping a volume of liquid nutrient composition.

Another embodiment uses a timer, not shown in the figures, to signal the pump to both turn on and off. In this manner, the embodiment is able to flood and drain one or more growing chambers 12 at a regular interval, or at any predetermined interval of time.

While the present invention has been illustrated and described by means of specific embodiments and alternatives, it is to be understood that numerous changes and modifications can be made without departing from the spirit and scope of the invention. Therefore, it should be understood that the invention is not to be limited in any way except in accordance with the appended claims and their equivalents.

1. A plant growth system comprising:
a vertically positioned source of light,
a reservoir,
a pump;
a volume of liquid based nutrient composition;
a plurality of stacked independent growing chambers arranged in a planar array around said one or more sources of light, each of said growing chambers comprising a container portion with a base and sides, an inflow/outflow gate accommodated in the base of said container portion, an height adjustable overflow gate accommodated within said container portion; and drainage plumbing connecting said container portion with said reservoir,
wherein each of said growing chambers accommodates one or more plant holding containers; and
wherein when said pump is activated, said pump transports said nutrient composition from the reservoir through the inflow/outflow gate into said growing chambers; and
wherein when one of said growing chambers becomes flooded to the level of said overflow gate, said overflowing nutrient composition is returned to said reservoir via said drainage plumbing;
and wherein when said pump is deactivated, said nutrient composition remaining in each growing chamber returns to the reservoir via the inflow/outflow gate.

2. The plant growth system as recited in claim 1, wherein there is a plurality of said vertically positioned sources of light.

3. The plant growth system as recited in claim 1, wherein said growing chamber is comprised primarily of a polyethylene material.

4. The plant growth system as recited in claim 1, wherein said inflow/outflow gate is a plurality of inflow/outflow gates.

5. The plant growth system as recited in claim 1, wherein said overflow gate is a plurality of overflow gates.

6. The plant growth system as recited in claim 1, wherein the pump is activated and deactivated by a timer.

7. A plant growth method comprising the steps of:
activating a pump wherein said pump transports a nutrient composition from a reservoir through an inflow/outflow gate into one or more growing chambers; and wherein when one or more of said growing chambers becomes flooded to the level of an overflow gate, said overflowing nutrient composition is returned to said reservoir via said overflow gate and drainage plumbing; and
deactivating said pump when said nutrient composition in each growing chamber is returned to said reservoir via said inflow/outflow gate
using an apparatus comprised of:
a vertically positioned source of light;
said reservoir,
said pump;
said nutrient composition;
a plurality of stacked independent growing chambers arranged in a planar array around one or more of said sources of light, each of said growing chambers comprising a container portion with a base and sides, an inflow/outflow gate accommodated in the base of said container portion, an height adjustable overflow gate accommodated within said container portion; and drainage plumbing connecting said container portion with said reservoir wherein each of said growing chambers accommodates one or more plant holding containers.

8. The plant growth method as recited in claim 7, wherein said vertically positioned source of light of said apparatus is comprised of a plurality of said vertically positioned sources of light.

9. The plant growth method as recited in claim 7, wherein said growing chamber of said apparatus is comprised of polyethylene material.

10. The plant growth method as recited in claim 7, wherein said inflow/outflow gate of said apparatus is comprised of a plurality of inflow/outflow gates.

11. The plant growth method as recited in claim 7, wherein said overflow gate of said apparatus is comprised of a plurality of overflow gates.

12. The plant growth method as recited in claim 7, wherein said apparatus if further comprised of a timer to activate and deactivate said pump.

13. (canceled)
